(19) United States
(12) Patent Application Publication
(10) Pub. No.: US 2019/0335744 A1
(43) Pub. Date: Nov. 7, 2019

(54) DECOY STAND

(71) Applicants: Andres Rodriguez, Belen, NM (US); Adrian Rodriguez, Belen, NM (US)

(72) Inventors: Andres Rodriguez, Belen, NM (US); Adrian Rodriguez, Belen, NM (US)

(21) Appl. No.: 16/400,251

(22) Filed: May 1, 2019

Related U.S. Application Data
(60) Provisional application No. 62/665,009, filed on May 1, 2018.

(51) Int. Cl. A01M 31/06; F16M 11/18; F16M 11/12

(52) U.S. Cl. CPC A01M 31/06; F16M 11/12; F16M 11/18

(57) ABSTRACT

A decoy mounting method, system, and apparatus comprises a decoy platform, a mount connected to the decoy platform, and a pole connected to the decoy platform by the mount. The decoy platform comprises a first stand wing, a second stand wing, and a connecting member connecting the first stand wing and the second stand wing. In an embodiment each of the first stand wing and the second stand wing further comprise a bottom section, a sloped wall section, and an upper section. In an embodiment, a motion creating assembly is configured to impart motion on a decoy mounted in the stand system.

### CROSS REFERENCE TO RELATED PATENT APPLICATIONS

This patent application claims the priority and benefit under 35 U.S.C. § 119(e) of U.S. Provisional Patent Application Ser. No. 62/665,009, filed May 1, 2018, entitled “DECOY STAND.” U.S. Provisional Patent Application Ser. No. 62/665,091 is herein incorporated by reference in its entirety.

### TECHNICAL FIELD

Embodiments are generally related to decoy stands. Embodiments are further related to decoy stands that allow water decoys to be used in other environments. Embodiments are also related to full body, land decoy arrangements. Embodiments are further related to methods and systems for manufacturing decoy stands. Embodiments are additionally related to methods and systems for decoy stands that incorporate movement, and are collapsible.

### BACKGROUND

As any waterfowler can attest, decoys are often an essential part of a sportsman's gear. In general, decoys are used to emulate the look of the desired quarry. Often a decoy will encourage an animal to approach the decoy.

While decoys can be highly effective, they are also problematic. Specifically, decoys are expensive and often difficult to transport. In addition, in the case of waterfowl, many decoys are specifically designed either to float on a body of water, or to stand independently on dry land. This means the sportsman is often faced with the proposition of acquiring two separate sets of decoys, one for use on land and the other for use on water. This is prohibitively expensive for many.

Furthermore, the realism of decoys can be greatly improved if they incorporate some movement. In many prior art approaches, decoys configured for use in water include a mechanism for providing some element of movement. However, that mechanism does not work when the decoy is set out on land. The movement mechanisms may be configured such that, on land, they make the decoy appear to tip or tilt in an unnatural way, decreasing the efficacy of the decoy.

Accordingly, there is a need in the art for improved methods, systems, and apparatuses that provide the ability to use decoys that can be used both in water and on land, incorporate movement, and reduce the difficulty of transportation as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide decoys.

It is another aspect of the disclosed embodiments to provide a decoy stand.

It is another aspect of the disclosed embodiments to provide methods, systems, and apparatuses that allow a water-based decoy to be deployed on land.

It is yet another aspect of the disclosed embodiments to provide methods, systems, and apparatus for a decoy stand that incorporates movement of the decoy and is collapsible.

The aforementioned aspects and other objectives and advantages can now be achieved as described herein. In an embodiment, a stand system or apparatus comprises a decoy platform, a mount connected to the decoy platform, and a pole connected to the decoy platform by the mount.

In an embodiment the decoy platform comprises a first stand wing, a second stand wing, and a connecting member connecting the first stand wing and the second stand wing. In an embodiment each of the first stand wing and the second stand wing further comprise a bottom section, a sloped wall section, and an upper section.

In an embodiment the mount further comprises a bolt and bearing mount. In an embodiment the bolt and bearing mount further comprises a coupling housing a bolt, a race and bearing assembly that accepts the bolt, and a pole port configured to engage with the pole.

In an embodiment the stand system further comprises a motion creating assembly configured to impart motion on a decoy mounted in the stand system. In an embodiment, the stand system further comprises a connecting linkage and a mounting plate.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a decoy stand, in accordance with the disclosed embodiments;

FIG. 2 depicts another embodiment of a decoy stand, in accordance with the disclosed embodiments;

FIG. 3 depicts components of a decoy stand, in accordance with the disclosed embodiments;

FIG. 4 depicts a ground stake associated with a decoy stand, in accordance with the disclosed embodiments;

FIG. 5A depicts a pole fitting, in accordance with the disclosed embodiments;

FIG. 5B depicts a pole fitting, in accordance with the disclosed embodiments;

FIG. 5C depicts a pole fitting, in accordance with the disclosed embodiments;

FIG. 6 depicts another embodiment of a decoy stand, in accordance with the disclosed embodiments;

FIG. 7A depicts another embodiment of a decoy stand, in accordance with the disclosed embodiments;

FIG. 7B depicts another embodiment of a decoy stand, in accordance with the disclosed embodiments;

FIG. 7C depicts an elevation view of a decoy stand, in accordance with the disclosed embodiments;

FIG. 8 depicts another embodiment of a decoy stand, in accordance with the disclosed embodiments;

FIG. 9 depicts a base and pillar support for a decoy stand, in accordance with the disclosed embodiments;

FIG. 10A depicts another embodiment of pole assembly for a decoy stand, in accordance with the disclosed embodiments;

FIG. 10B depicts another embodiment of pole assembly for a decoy stand, in accordance with the disclosed embodiments;

FIG. 11A depicts an alternative decoy stand arrangement, in accordance with the disclosed embodiments;

FIG. 11B depicts an alternative decoy stand arrangement, in accordance with the disclosed embodiments;

FIG. 11C depicts an alternative decoy stand arrangement, in accordance with the disclosed embodiments;

FIG. 11D depicts an alternative decoy stand arrangement, in accordance with the disclosed embodiments;

FIG. 12A depicts a motion generating assembly, in accordance with the disclosed embodiments;

FIG. 12B depicts a motion generating assembly, in accordance with the disclosed embodiments;

FIG. 13A depicts a motion generating assembly, in accordance with the disclosed embodiments;

FIG. 13B depicts a motion generating assembly, in accordance with the disclosed embodiments;

FIG. 14 depicts a motion generating assembly attached to a decoy stand, in accordance with the disclosed embodiments; and

FIG. 15 depicts steps associated with a method for using a decoy stand, in accordance with the disclosed embodiments.

### DETAILED DESCRIPTION

Subject matter will now be described more fully hereinafter with reference to the accompanying drawings, which form a part hereof, and which show, by way of illustration, specific example embodiments. The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements, or method steps.

The term “or combinations thereof” as used herein refers to all permutations and combinations of the listed items preceding the term. For example, “A, B, C, or combinations thereof” is intended to include at least one of: A, B, C, Aft AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, Aft BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those skilled in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

It should be appreciated that the dimensional and material descriptions provided in the drawings and specification are meant to be exemplary and other sizes can be used in other embodiments.

The embodiments disclosed herein are directed to methods, systems, and apparatuses for decoy stands that allow decoys to be deployed on land or in water. Thus, while the embodiments disclosed herein are generally directed to duck decoys, decoys for other species of birds or mammals (such as, dove, geese, small game, turkey, grouse, etc.) could also be used according to the systems and methods disclosed herein. it should be understood that in other embodiments, the various methods and systems disclosed herein can be used for other species of animal.

It should also be understood that many decoys, designed for deployment in water, are configured with a keel on the bottom side. While the decoy floats, the keel holds the direction of the decoy in the water and keeps the decoy from unnaturally tipping or tilting. There are multiple associated sizes and shapes on the market, depending on brand. The decoy stands disclosed herein are designed to accommodate all different sizes and shapes of decoys or decoy keels. In certain embodiments, the platform and/or retention dowels can be configured to interface with, and hold, the keel of a decoy designed for water applications.

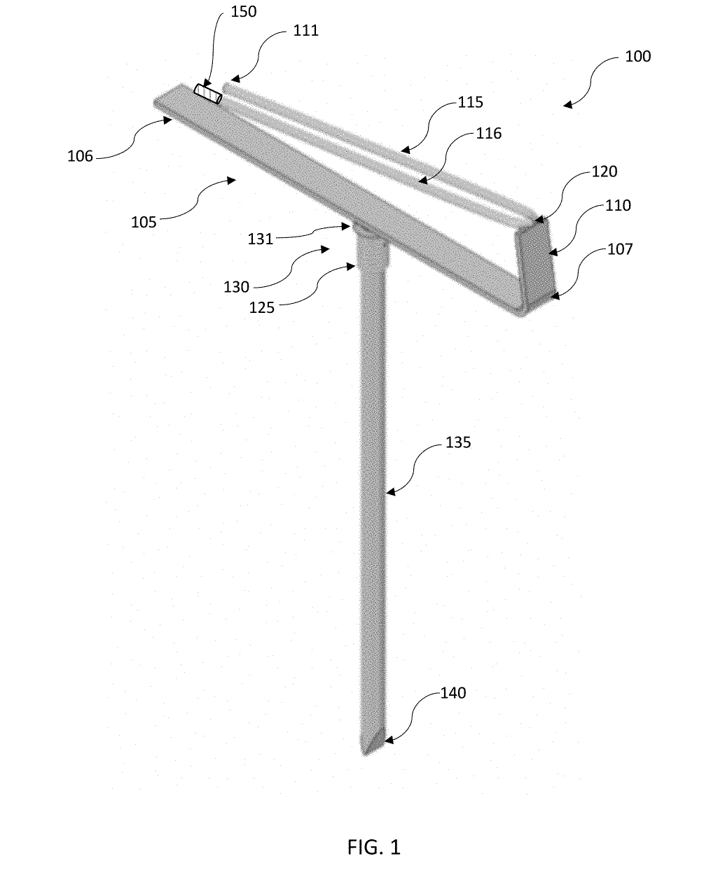

In an embodiment, illustrated in FIG. 1, the decoy stand 100 can comprise a base or platform 105 that holds the decoy. The platform 105 generally comprises a base plate 106 with a vertical bend 117, and a substantially vertical raised end 110. In general, the base plate 106 can be an elongated substantially flat base. In other embodiment the base plate 106 can also have other shapes such as a horseshoe, V-shape, cup-shape, etc., to hug the keel of a decoy. In other embodiments, the base plate 106 can incorporate a clamp, clip on, or slide on apparatus.

The platform 105 can be formed of metal, plastic, rubber, fiberglass, nylon, steel, carbon fiber or any rust-resistant or freeze-resistant material. Rust or freeze resistant materials are particularly useful because the stand is often employed in cold, wet conditions. The material can also be coated or colored to reduce its visibility and/or shine. In some cases, this can include a camouflage pattern, or other such visibility/shine reducing coating. The stand 100 can be any color and/or texture selected to match the environment or species of duck decoy, which can include a camouflage pattern, or other such visibility/shine reducing coating.

A set of retention dowels, including dowel 115 and dowel 116 can be connected to the vertical end 110 of the platform 105 at joint 120. The retention dowels 115 and 116 run substantially parallel to one another, and substantially parallel to, and above the platform 105. In certain embodiments, the retention dowels 115 and 116 comprise tubular dowels or bars.

The retention dowels 115 and 116 can be formed to have a number of shapes according to design considerations. For example, in one embodiment, the retention dowels 115 and 116 can be substantially straight tubular members. In another embodiments, the retention dowels 115 and 116 can be shaped with bends or joints to match the profile of a desired decoy. This can include for example, a slight wave or waves, that mirror the profile of a decoy or a decoy keel. In certain embodiments, the bend in dowel 115 can be mirrored by the bend in dowel 116 so that the respective retention dowels 115 and 116, fit around a decoy. In other embodiments, the bends in the retention dowels may be asymmetrical, in order to properly fit the asymmetrical contour of a decoy. In certain embodiments, the retention dowels can be flexible so that their shape can be adjusted to match the shape of the decoy or decoy keel being used.

The retention dowels 115 and 116 are further configured such that they are connected at joint 120 to the vertical end 110 of the platform 105 formed on one end. On the distal end 111, the retention dowels 115 and 116 can be open or free. This serves two functions. First, a decoy base or decoy keel can slide into place on the platform 105 between the retention dowels 115 and 116, from the free distal end 111.

Additionally, the joint 120 at the vertical raised end 110 of the platform 105 provides a spring like inward contracting force on the retention dowels 115 and 116, such that a decoy can be securely held in place between them. Each of retention dowel 115 and retention dowel 116 can apply an inward pressure, resulting from the connection at joint 120, on the decoy or decoy keel.

In other embodiments, the joint 120 can comprise a hinge. In such embodiments, the retention dowels 115 and 116 can connect to the base plate 106 with the hinge allowing, a user to “open” the retention dowels 115 and 116 outward, install a decoy on the base plate 106, and then “close” the retention dowels 115 and 116, on or around the decoy or decoy keel. This flexibility allows the retention dowels 115 and 116 to accommodate different brands of decoys and different sizes of decoys.

In certain embodiments, the retention dowels 115 and 116 can have a spring 150 that attaches to the free distal end 111 of the retention dowels 115 and 116. The spring 160, can be connected to dowel 115, stretched around the decoy keel, and then connected to the dowel 116, to hold it in place.

In other embodiments, the decoy can hang freely between the dowels 115 and 116 (i.e. no base plate 106 is provided beneath).

The platform 105 can be configured to engage a mounting stand with a mount 130. In FIG. 1, mount 130 is embodied as a spring mount 130. The spring mount 130 comprises a cup 131 engaged to, or otherwise formed on platform 105 that accepts, and holds, a spring 125 therein. In certain embodiments, a post can extend out of the cup 131 and the spring can be engaged over the post into the cup 131. The spring 125 can also be permanently attached to the platform 105 by welding or any other such means. The other end of spring 125 can be attached to a mounting stand 135, generally configured as a pole. The spring 125 is fitted over or in the top end of the pole 135.

The mount 130 is configured to allow a user to impart motion on a decoy held in the stand 100. Motion can be created manually via a string, rope, lanyard, etc. connected to the stand. In an embodiment, motion can also be imparted on the decoy electronically with a motor connected to a battery, or solar power. Movement can also be created with wind vanes attached to the platform 105 or pole 135, where even slight movement of the stand creates a moving effect via the spring 125.

In certain embodiments, the opposing end 141 of the pole 135 can comprise a point or spike 140 such that the pole 135 can be driven into the ground. The pointed end 140 of the pole 135 facilitates insertion of the opposing end 141 of pole 135 into the ground. In some cases, a hammer or other such driving device to force can be used to secure the pole 135 into the ground. In such embodiments, the spring 125, mounted in the spring mount 130 can be inserted over the top end of the pole 135 once it has been driven into the ground.

The stand 100 is thus ready to accept a decoy which can be slid into place between the retention dowels 115 and 116. The spring 125 allows the decoy to move by external force, some movement mechanism associated with the decoy, and/or as a result of wind or other such environmental force.

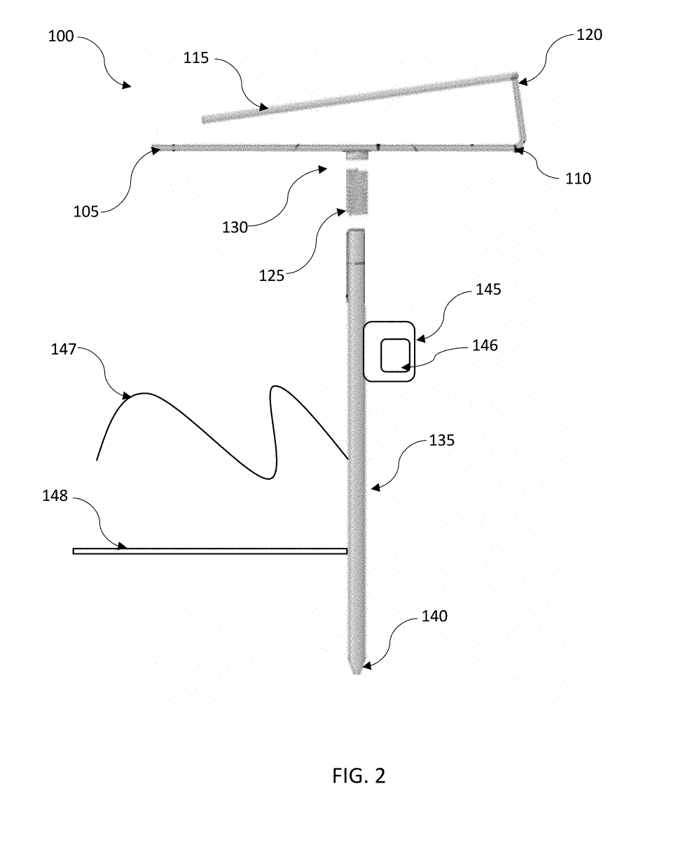

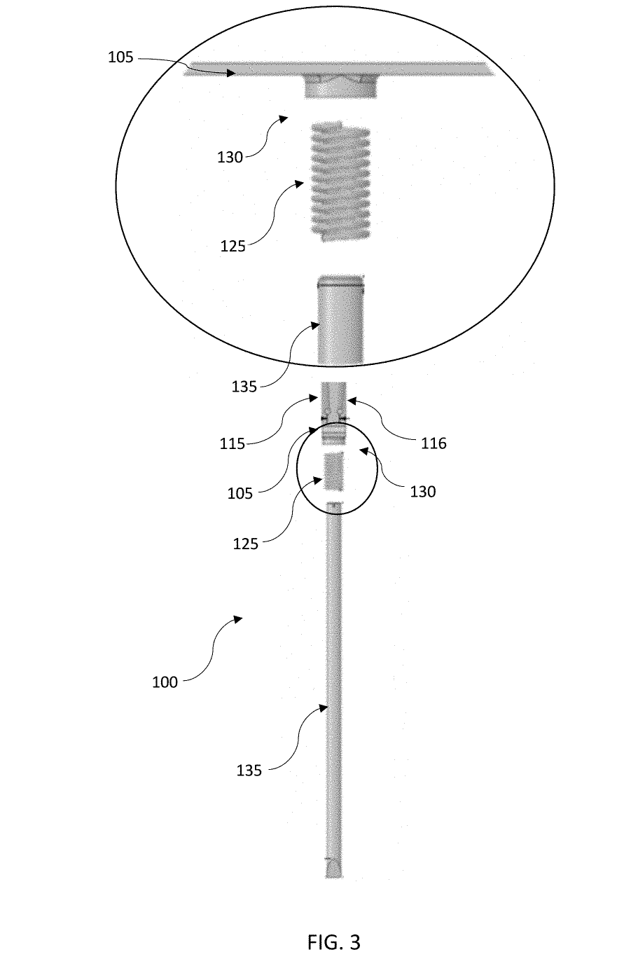

FIG. 2 and FIG. 3 illustrate further views of the stand 100. For example, in FIG. 2, a motor 145 is illustrated attached to the pole 135. The motor can comprise a vibrating motor and/or electric motor powered by a power source 146 that can comprise a battery or solar collector. The motor 145 can be configured to turn on and off intermittently. In other embodiments, the motor 145 can be activated via remote control or activated with a wireless (e.g. Bluetooth, near field, etc.) connection to a mobile device. In certain embodiments, pull-string 147 and/or push-rod 148 can be connected to the pole 135 or platform 105, in order to induce movement of the decoy. In certain embodiments, the motor 145 be attached directly to the platform 105. The motor 145 can also be used in place of the spring 125 to create motion.

The pole 135 can be telescoped to provide the ability to adjust the height of the decoy from the ground (optimally about 4 inches off the ground, but in other cases other heights may be desirable).

In certain embodiments, the pole 135 can be replaced with, or further comprise, a platform that engages the spring 125 to be used on frozen or hard surfaces where the spike 140 cannot be driven into the ground. The pole 135/platform 105 can be made of plastic, fiberglass, metal, carbon fiber, nylon, or any other rust-resistant and/or freeze-resistant material.

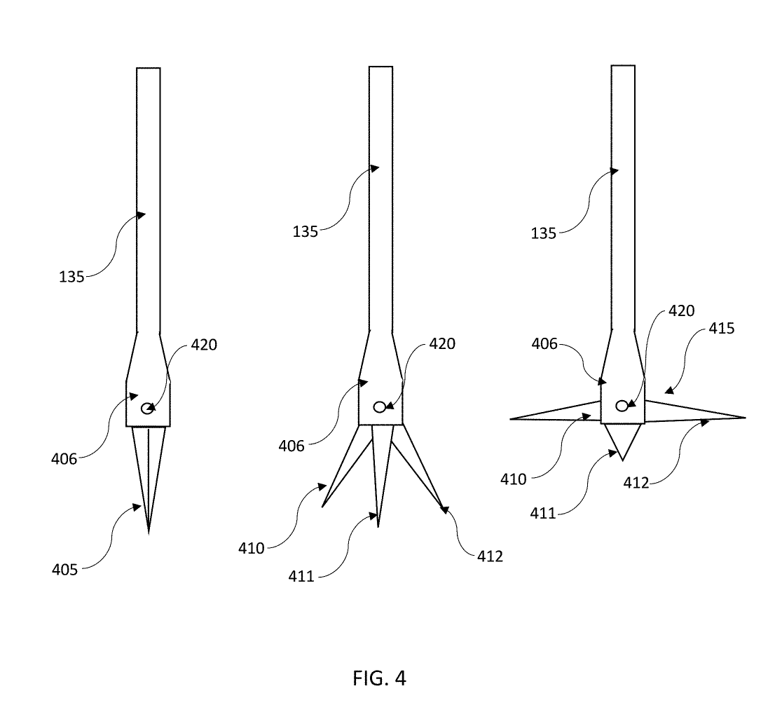

FIG. 4 illustrates another embodiment of the pole 135. The pole 135 can further comprise a flared bottom end 406, that houses a deployable stake 405. In such an embodiment, the deployable stake 405 comprises one or more spikes 410, 411, and 412. When the spikes 410, 411, and 412 are undeployed they can fit together to form a single spike 416 that can be driven into the ground.

To deploy the spikes 410, 411, and 412, a release 420 can be used. The release comprises a button operably attached to a tensioned collar formed in the flared end 406 of pole 135. Operation of the release 420, releases the tension in the collar so that spikes 410, 411, and 412 can be separated. The deployed spikes 410, 411, and 412 can be attached to the bottom end 406 of the pole 135. The spikes 410, 411, and 412 can be deployed from the hollow flared end 406 of pole 135 and configured into a stand or platform 415 that allows the stand 100 to be deployed where it cannot be staked into the ground.

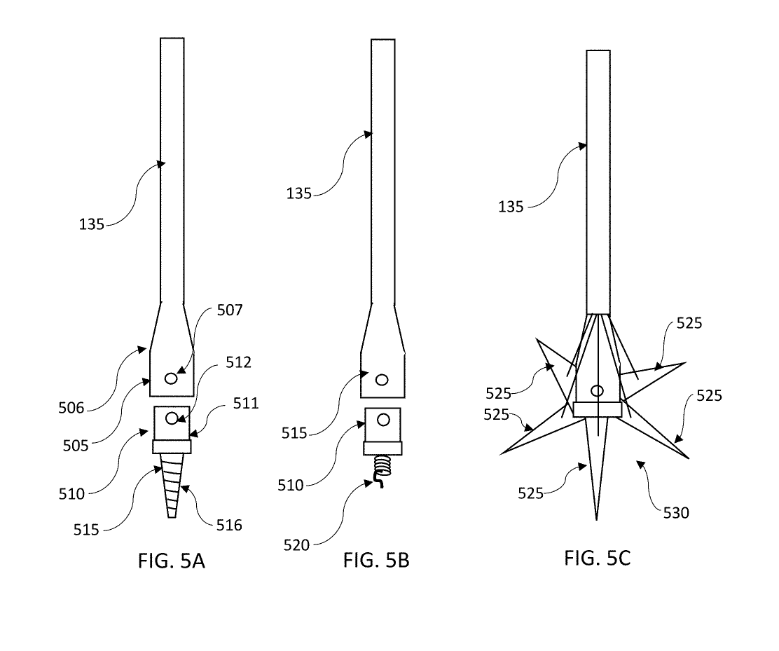

In another embodiment, illustrated in FIGS. 5A-5C, the pole can be fitted with a pole fitting that can engage with various connection interfaces. The pole fitting can include a peg and hole connection for securing the various connection interfaces with the pole 135. Other forms of connections can include a snap-on connection, a clip-on connection, a screw-in connection, any similar type of fastener, a magnetic connection, a tied or bound connection, and/or connection with an adhesive. In other embodiments, other securing mechanisms can also be used.

In an exemplary embodiment, the pole fitting 505 comprises a flared port 506 with a hole 507. The connection interface 510 comprises a plug 511 that fits inside the flared port 506. The connection interface 510 further comprises a spring loaded button 512, that fits through the hole 507 to secure the connection interface 510 in the flared port 506.

In FIG. 5A, the connection interface 510 can include a ground screw 515 with external ground threads 516. Once the ground screw 515 is secured to the pole 135 via the connection interface 510 and pole fitting 505, the assembly can be twisted into the ground.

In FIG. 5B the connection interface comprises a loose screw 520. Again, once the loose screw 520 is secured to the pole 135 via the connection interface 510 and pole fitting 505, the assembly can be twisted into the ground.

In FIG. 5C another embodiment is illustrated. In this embodiment, a plurality of legs 525 can be connected to the pole 135 with an assembly essentially equivalent to an umbrella with extending legs. The deployment mechanism can release the plurality of legs from the pole 135 such that the legs form a platform 530.

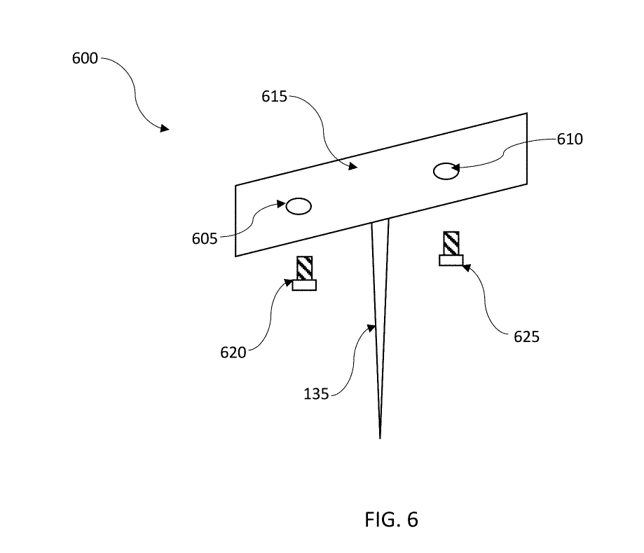

In FIG. 6, another embodiment of a decoy stand 600 is illustrated. The decoy stand 600, comprises a set of one or more holes, such as hole 605 and hole 610 that can be formed in a platform 615. The platform 615 can hold a decoy. The decoy can be screwed to the platform 615 with one or more screws such as screw 620 and screw 625. The platform 615 can be connected to any of the pole 135 and/or stake assemblies disclosed herein, along with the mount 130 to impart movement on the decoy on the platform 615.

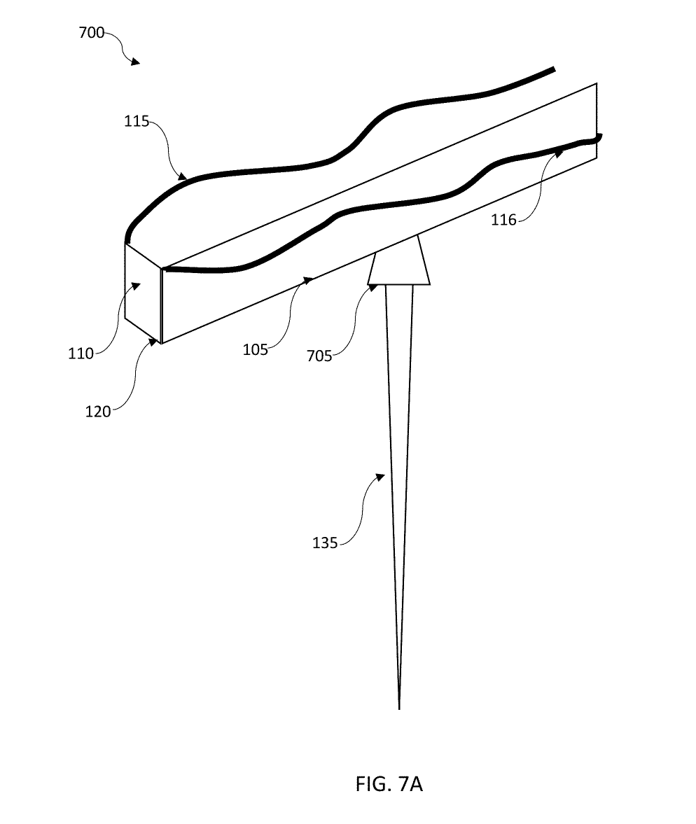

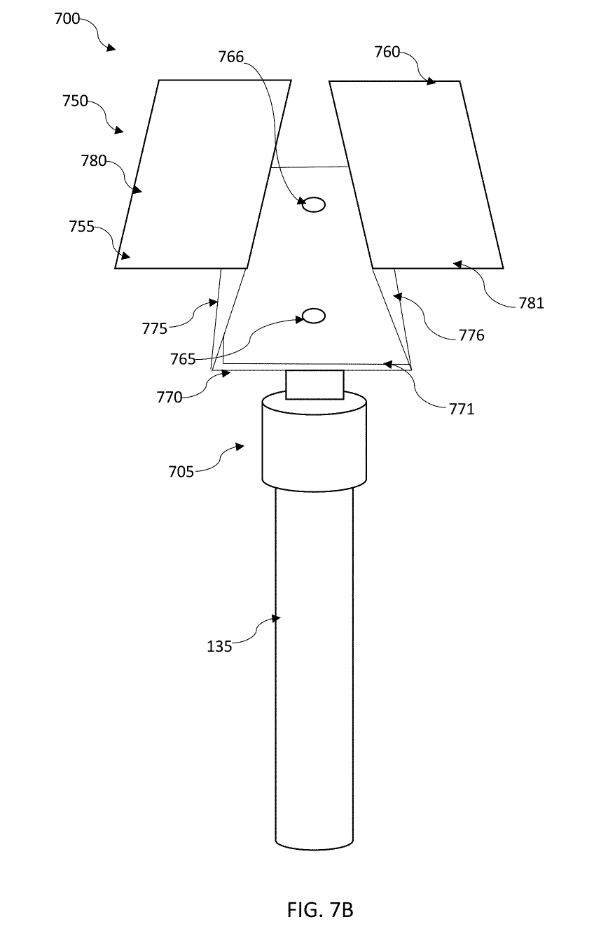

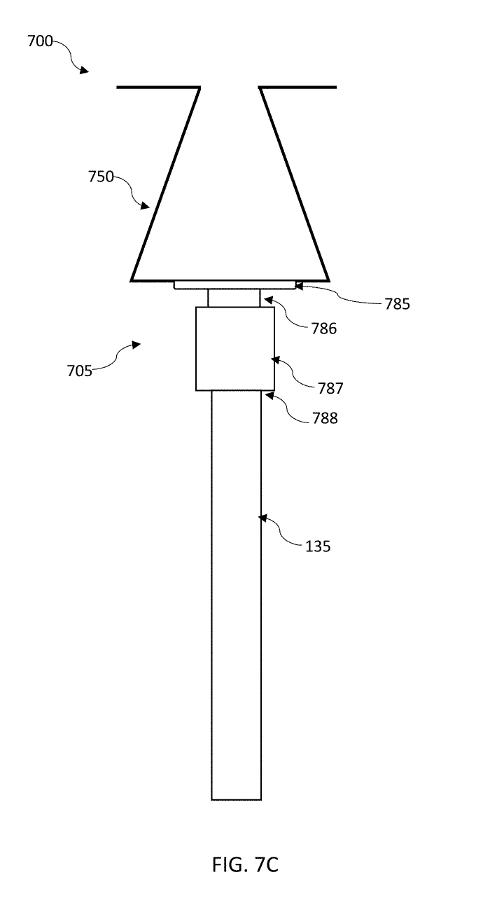

FIG. 7A, illustrates another embodiment of a stand 700 wherein the platform 105 can be configured with a mount 705. The mount 705 can comprise a bearing and race assembly. The mount 705 connects the platform 105 and pole 135, and provides an alternative mechanism for imparting movement of the decoy when it is deployed on the platform 105. The connection between the platform 105 and pole 135 via the mount 705 comprising the bearing and race assembly can be permanent or removable. Movement can be engaged by wind motion, an electrical motor, a pull-string, a push-rod, or by any other means as disclosed herein.

FIG. 7B, illustrates another embodiment of the stand 700 configured with an alternative decoy platform 750. In this embodiment, the decoy platform 750 comprises two stand wings, stand wing 755 and stand wing 760, connected by connecting member 765 and connecting member 766. Connecting member 765 and connecting member 766 can comprise rivets, bolts and nuts, screws, or other such connecting devices.

Stand wing 755 comprises a Z-shaped member with a substantially horizontal bottom section 770, sloped wall section 775, and substantially horizontal upper section 780. Stand wing 760 comprises a Z-shaped member with a substantially horizontal bottom section 771, sloped wall section 776, and substantially horizontal upper section 781. Two holes can be formed in the substantially horizontal bottom sections 770 and 771 of stand wing 755 and stand wing 760 respectively. In an exemplary embodiment, each of stand wing 755 and stand wing 760 comprises a single piece of molded plastic, metal, rubber, or other such material.

The horizontal bottom section 770 of stand wing 755 and the horizontal bottom section 771 of stand wing 760 overlap so that the holes therein are aligned. Connecting member 765 can be inserted through one set of aligned holes and connecting member 766 can be inserted through the other set of aligned holes, so that the stand wing 755 and stand wing 760 are bound together to form the decoy platform 750.

Once the stand wing 755 and stand wing 760 are bound together, the sloped wall section 775 of stand wing 755 is sloped toward the sloped wall section 776 of stand wing 760. The inwardly sloping walls of the decoy platform 750 serve to hold a decoy or decoy keel therebetween. The substantially horizontal upper sections 780 and 781 respectively, can also provide balance to the decoy body when the decoy keel is inserted between the sloped wall sections of the decoy platform 750.

In FIG. 7C, an elevation view of the decoy platform 750 is illustrated. the mount 705 can comprise a bolt and bearing system. The bolt and bearing system mount 705 can further comprise a coupling 785 formed on the bottom of the decoy platform 750. The coupling houses a bolt 786 that extends into a race and bearing assembly 787. The race and bearing assembly 787 accepts the bolt in the race and allows the bolt to spin. The bottom of the race and bearing assembly comprises a pole port 788 that is hollow to provide engagement with the pole 135. It should be noted that in some embodiments, the pole 135 can be threaded and can engage with threading from on the interior of the hollow portion of the race and bearing assembly 787. In other embodiments, the pole 135 can be inserted into the hollowed portion of the race and bearing assembly and is held in place with friction.

The bolt and bearing system mount 705 adds rotational movement to the decoy stand 700. movement of the decoy stand can be achieved with a motor, or via manual manipulation as described with respect to other embodiments.

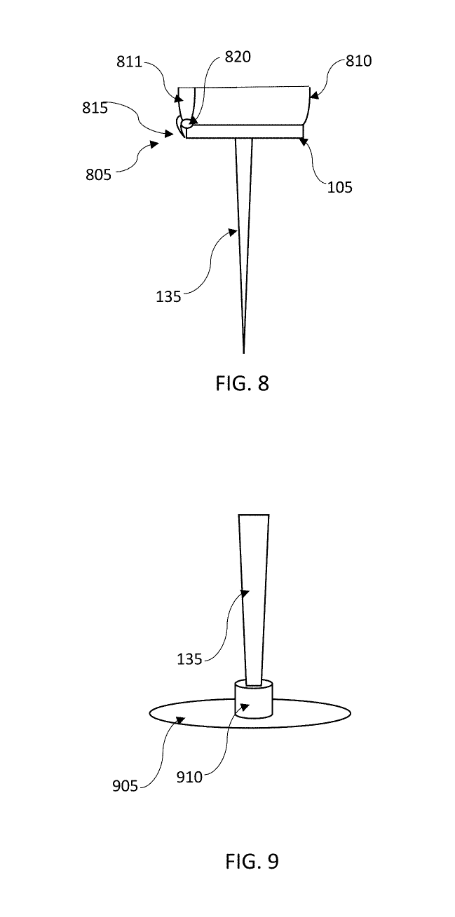

FIG. 8 illustrates an embodiment wherein the platform 105 further includes a clamp 805. In this embodiment, the clamp 805 comprises clamping arm 810 and clamping arm 811. A spring 820 biases clamp arm 810 toward clamp arm 811. A clamp opening mechanism 815 can be used to draw clamping arm 810 away from clamping arm 811. A decoy or decoy keel can be inserted between clamping arm 810 and clamping arm 811 and then the clamp opening mechanism 815 can be released so that the clamping arms 810 and 811 close around the decoy and/or decoy keel.

In yet another embodiment illustrated in FIG. 9, a base stand 905 can be configured to include a support pillar 910, wherein the pole 135 can be inserted. The base serves to hold the stand up on the ground when the stake cannot be inserted in the ground.

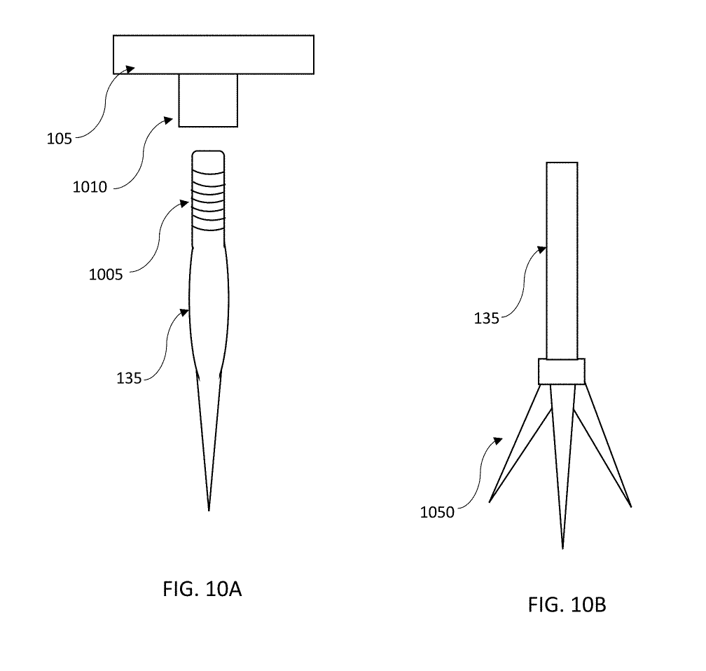

FIG. 10A illustrates another embodiment wherein the pole 135 is threaded at the top end with male threads 1005. The male threads 1005 are configured to be screwed into a female threaded pillar 1010 formed on the platform 105. This allows the pole 135 to be fixedly engaged with the platform 105. In another embodiment shown in FIG. 10B, a set of legs 1050 can be connected to the pole 135. The legs can be deployed to from a platform/tripod to be used in the event that the stake cannot be driven in the ground.

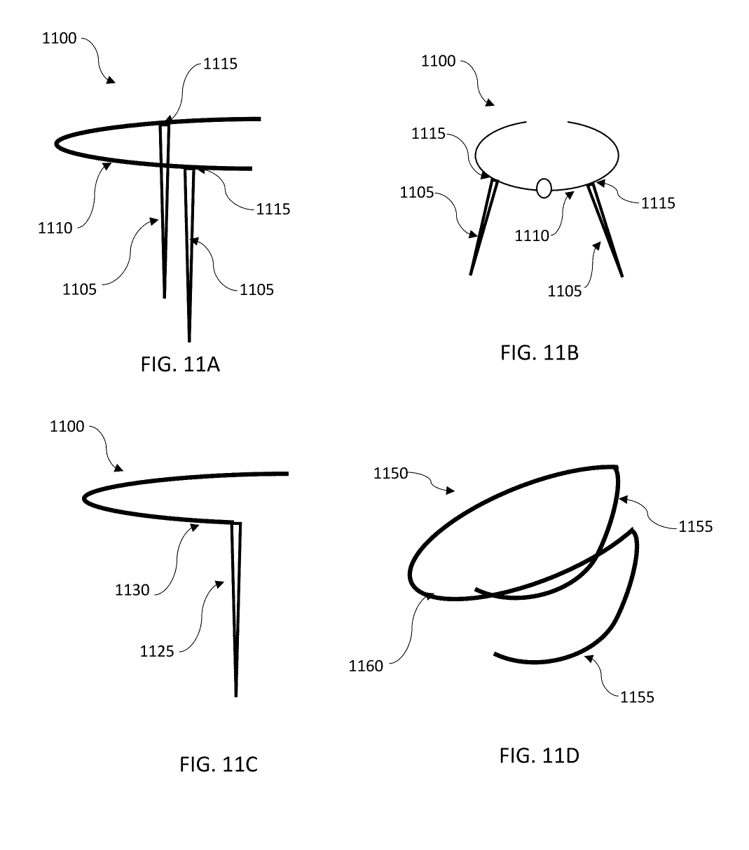

FIGS. 11A-11D illustrate a series of alternative decoy stand arrangements, in accordance with the disclosed embodiments. In the embodiments, illustrated in FIGS. 11A-11D, a decoy or decoy keel can slide into place in the stand 1100.

In FIGS. 11A and 11B, the stand 1100 comprises one or more legs 1105. In certain embodiments, the legs can be integrated into a wire holder 1110. The wire holder 1110 can comprise a metal or plastic rim configured to hold a decoy or decoy keel. In the embodiments illustrated the wire holder 1110 is c-shaped but in other embodiments, the shape of the wire holder 1110 can be selected to match a decoy body or the keel of a decoy.

In certain embodiments, the legs 1105 comprise a leg mounts 1115 that can further comprise tubular conduits that slide onto the wire frame 1110. This allows the legs 1105 to be adjusted to ensure the stand 1100 properly balances once a decoy is deployed thereon. In other embodiments, the leg mounts 1115 can comprise c-shaped snaps that can snap onto the wire holder 1110. The legs 1105 can include any of the associated characteristics of pole 135 as disclosed herein.

One or more of legs 1105 can be mounted to wire holder 1110 with leg mounts 1115 to manage the weight of the decoy. More legs 1105 can be used in other embodiments. The parts of stand 1100 can be made out of plastic, fiberglass, carbon fiber, metal, nylon, or any other rust-resistant and/or freeze-resistant material. They may be shaped in a number of alternative ways that allows them to be staked into the ground. They can also be shaped with a platform like base, so that they can be placed on the ground, and/or shaped in a way that cradles the decoy to be placed on the ground.

In FIG. 11C an additional embodiment of a stand 1100, is illustrated. In the embodiment a stake 1125 and wire frame 1130 are integrated into a one piece stand 1100. The shape of wire frame 1130 can be configured to match the shape of the decoy or decoy keel being inserted (e.g. slid) therein. The stands 1100 can be made out of plastic, fiberglass, carbon fiber, metal, nylon, or any other rust-resistant and/or freeze-resistant material. They can be shaped in a number of alternative ways that allows them to be staked into the ground. They can also be shaped with a platform like base, so that they can be placed on the ground, and/or shaped in a way that cradles the decoy to be placed on the ground.

In FIG. 11D an additional embodiment of a decoy stand 1150 is illustrated. In this embodiment, the wire frame 1160 can be connected to, or integrated with, a set of turned down legs 1155. The turned down legs 1155 allow the decoy to rock, in order to provide realistic decoy motion. The turned down legs 1155 can also have spring-like shapes to facilitate vertical and/or horizontal motion of the decoy. The decoy or decoy keel can fit in the wire frame 1160 which can be shaped as described with respect to other embodiments, to hold a decoy or decoy keel.

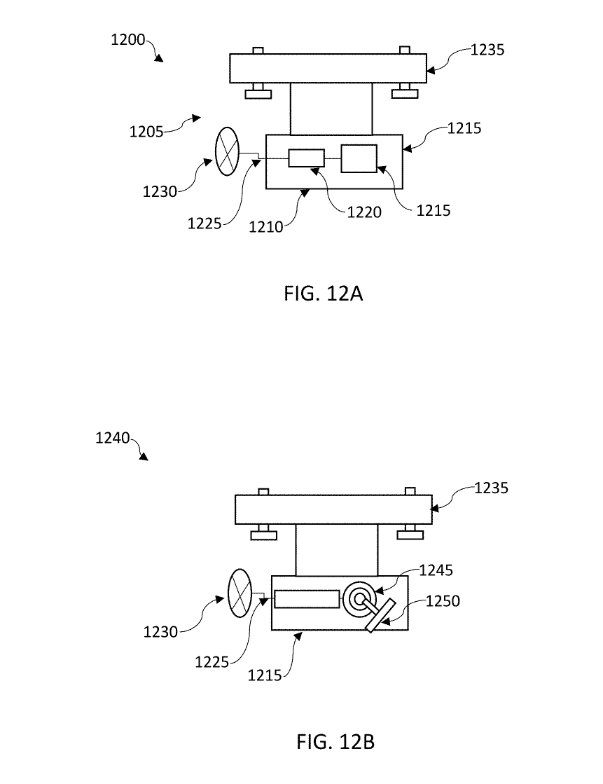

FIG. 12A illustrates a motion creating assembly 1200, that can be used in concert with other aspects of the disclosed embodiments to impart motion on a decoy. FIG. 12A illustrates an electric powered propeller assembly 1205. In this embodiment a housing 1210, house a power supply 1215 connected to an electric motor 1220. The electric motor 1220 is connected to a drive shaft 1225. A switch or other control mechanism can be used to turn the electric motor 1220 on. The electric motor 1220 is configured to drive the drive shaft 1225 which is connected to a propeller 1230. The housing 1210 is further connected to a mounting plate 1235 that allows the motion creating assembly 1200 to be engaged to a decoy, decoy keel, or stand platform such as platform 105.

FIG. 12B illustrates a similar wind up powered assembly 1240. In this embodiment a spring 1245 can be turned with crank 1250 such that potential energy is stored in the spring's coils. When the crank 1250 is released the spring 1245 imparts rotational motion on the drive shaft 1225. The drive shaft 1225 is connected to a propeller 1230. As above, the housing 1210 is connected to a mounting plate 1235 that allows the motion creating assembly 1240 to be engaged to a decoy, decoy keel, or stand platform such as platform 105.

The embodiments illustrated in FIGS. 12A and 12B can be used to impart motion on a decoy deployed either in the water or deployed using a stand, such as stand 100, as disclosed herein, out of the water.

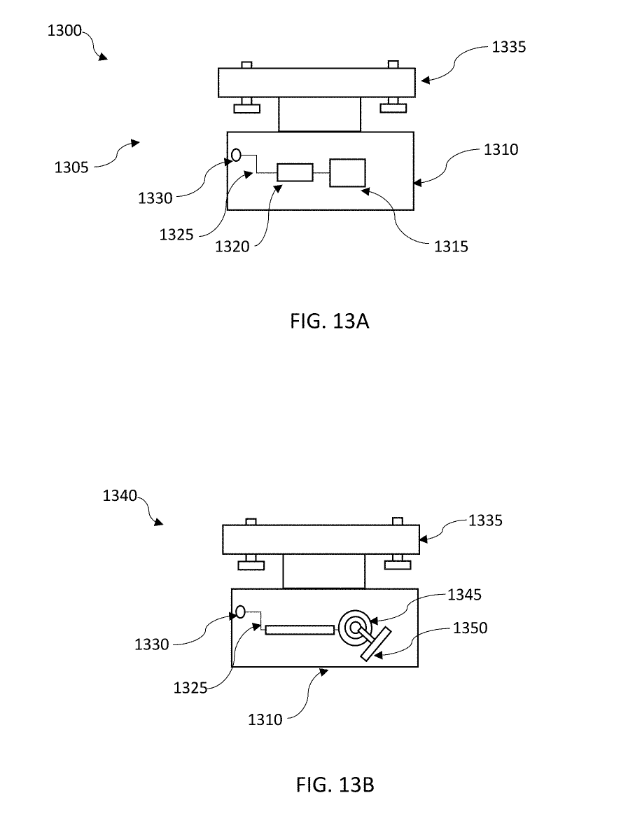

FIG. 13A illustrates another embodiment of a motion creating assembly 1300, that can be used in concert with other aspects of the disclosed embodiments to impart motion on a decoy. FIG. 13A illustrates an electric powered wobble assembly 1305. In this embodiment a housing 1310, houses a power supply 1315 connected to an electric motor 1320. The electric motor 1320 is connected to a drive shaft 1325. A switch or other control mechanism can be used to turn the electric motor 1320 on. The electric motor 1320 is configured to drive the drive shaft 1325 which is connected to an offset weight 1330. Rotational motion is imparted on the offset weight 1330 via the drive shaft 1325. As the offset weight, turns vibration or wobbling is created. The housing 1310 is further connected to a mounting plate 1335 that allows the motion creating assembly 1300 to be engaged to a decoy, decoy keel, or stand platform such as platform 105.

FIG. 13B illustrates a similar wind up powered assembly 1340. In this embodiment a spring 1345 can be turned with crank 1350 such that potential energy is stored in the spring's coils. When the crank 1350 is released the spring 1345 imparts rotational motion on the drive shaft 1325. The drive shaft 1325 is connected to an offset weight 1330. Rotational motion is imparted on the offset weight 1330 via the drive shaft 1325. As the offset weight turns, vibration or wobbling is created. The housing 1310 is further connected to a mounting plate 1335 that allows the motion creating assembly 1300 to be engaged to a decoy, decoy keel, or stand platform such as platform 105.

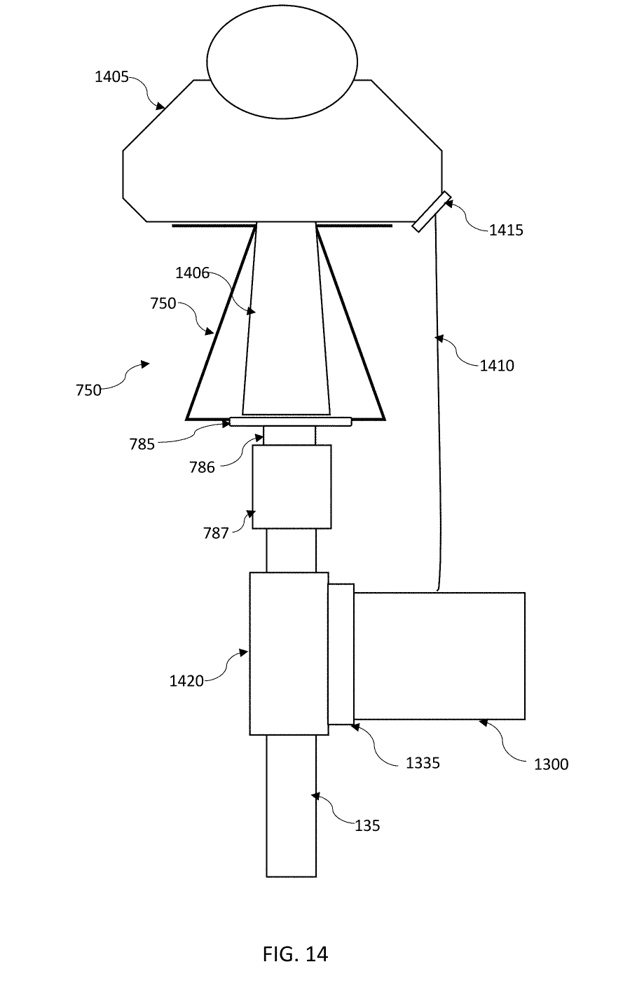

FIG. 14, illustrates an exemplary embodiment of a motion creating assembly 1300 (or 1200) connected to a stand 700 in accordance with the disclosed embodiments. It should be appreciated that any of the motion creating assemblies disclosed herein can also be connected to any embodiment of a stand as disclosed herein.

In FIG. 14, a decoy 1405 is inserted into a mount 705. In the embodiment illustrated in FIG. 14, the decoy 1405 comprises a water based decoy with a keel 1406, which is held in the decoy platform 750. The mount 705 can be used for land based use of the decoy 1405 by inserting pole 135 in the ground.

A motion generating assembly 1300 can be mounted to the pole 135. The pole 135 can be fitted with a mounting sleeve 1420 that is configured to connect to the motion generating assembly 1300 via mounting plate 1335. A connecting linkage 1410 can be connected to the housing of the motion generating assembly 1300. The connecting linkage 1410 can be a string, pole, chain, fishing line, or other such device.

The connecting linkage 1410 can be connected to the decoy 1405 with a mounting plate 1415. The mounting plate 1415 can comprise a rigid or semi-rigid plate with a sticky interface. In other embodiments, the mounting plate 1415 can be mounted to the decoy with a rivet, screw, or other such connecting device. In still other embodiments, the mounting plate can be connected to the mount 705 to impart motion on the decoy 1405.

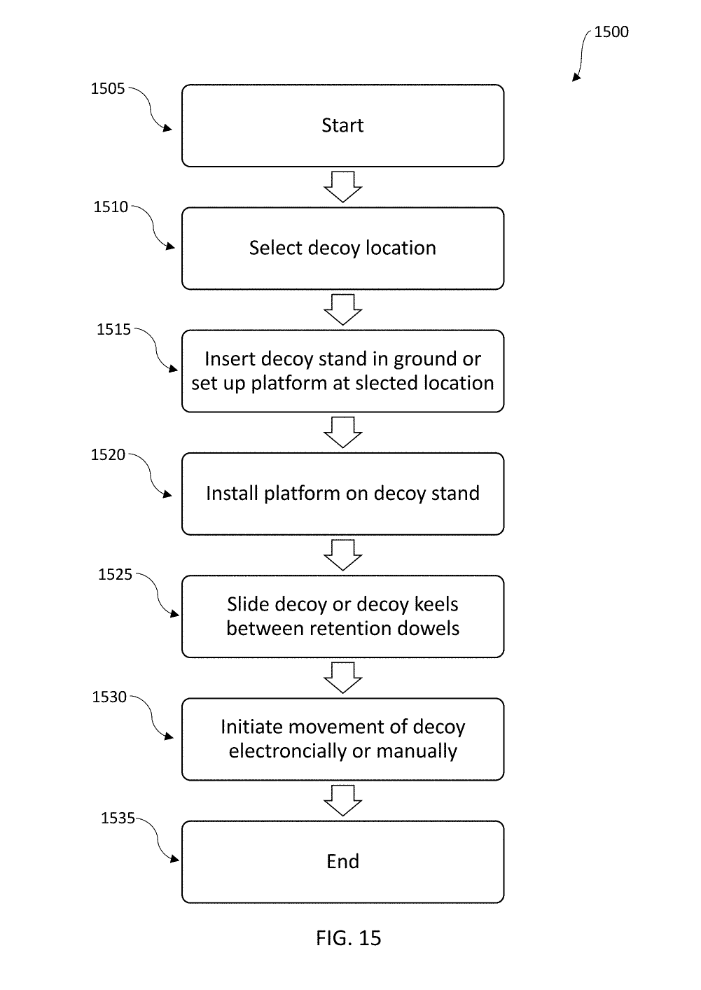

FIG. 15 illustrates a flow chart of steps associated with a method 1500 for decoying. The method begins at 1505. At step 1510 a desired decoy location can be selected. Notably, it may commonly be the case that the selected decoy location is an aquatic location, s stream or river, a shallow water location, a marsh, a dry ground location, or some combination thereof. At step 1515 decoy stands can be inserted into the ground where the ground is amenable to insertion. In some circumstances this may require pounding with a hammer, sledge, or other such device. In some cases, a selection of dry land locations can be selected with other locations in the water. In such cases, the poles can be inserted in the dry land locations, some or all of the aquatic environments, or none of the aquatic environments. In some cases, where the dry land is not amenable to pole insertion (e.g. the ground is rocky or otherwise too dense for inserting a pole), the embodiments disclosed herein that make use of a ground platform can be used.

With the poles properly deployed in the selected locations, a platform can be installed on each pole as shown at 1520. Note that the platform can be installed via the spring or bearing assembly to ensure natural movement of the decoy. In certain embodiments, installing the platform can include, installing and or initiating an electric motor to induce motion of the decoy. At step 1525, the decoy or decoy keel can be slid between the retention dowels into position on the platform.

The decoys are now ready for use, and motion of the decoys can be initiated either manually or via an electronic motor or other such device at 1530. The method ends at 1535.

Based on the foregoing, it can be appreciated that a number of embodiments, preferred and alternative, are disclosed herein. In an embodiment, a stand system comprises a decoy platform, a mount connected to the decoy platform, and a pole connected to the decoy platform by the mount.

In an embodiment, the decoy platform comprises a first stand wing, a second stand wing, and a connecting member connecting the first stand wing and the second stand wing. In an embodiment each of the first stand wing and the second stand wing further comprise a bottom section, a sloped wall section, and an upper section.

In an embodiment, the mount further comprises a bolt and bearing mount. In an embodiment the bolt and bearing mount further comprises a coupling housing a bolt, a race and bearing assembly that accepts the bolt, and a pole port configured to engage with the pole.

In an embodiment, the stand system further comprises a motion creating assembly configured to impart motion on a decoy mounted in the stand system. In an embodiment the stand system further comprises a connecting linkage and a mounting plate.

In another embodiment, a decoy stand apparatus comprises a decoy platform, a mount connected to the decoy platform, the mount comprising a bolt and bearing mount, and a pole connected to the decoy platform by the mount. In an embodiment, the decoy platform comprises a first stand wing, a second stand wing, and a connecting member connecting the first stand wing and the second stand wing.

In an embodiment, the bolt and bearing mount further comprises a coupling housing a bolt, a race and bearing assembly that accepts the bolt, and a pole port configured to engage with the pole.

In an embodiment, the decoy stand apparatus further comprises a motion creating assembly configured to impart motion on a decoy mounted in the stand system. The apparatus further comprises a connecting linkage and a mounting plate.

In an embodiment, the decoy stand apparatus further comprises at least one of a spike connected to a distal end of the pole, and a base stand connected to a distal end of the pole.

In yet another embodiment, a stand system comprises a platform, a set of retention dowels fixed at one end to the platform, and a pole connected to the platform.

In an embodiment, the stand system further comprises a spring mount formed on the platform and a spring connected to the spring mount and the pole.

In an embodiment, the retention dowels are configured to engage at least one of a decoy, and a keel of a decoy.

In an embodiment, the stand system further comprises a spike formed on an end of the pole. In an embodiment the stand system further comprises a base stand formed on an end of the pole.

In an embodiment of the stand system, the platform further comprises a base, a vertical bend in the base plate, and a substantially vertical raised end. In an embodiment the stand system further comprises a joint connecting the vertical raised end to the set of retention dowels.

It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A stand system comprising:
a decoy platform;
a mount connected to said decoy platform; and
a pole connected to said decoy platform by said mount.

2. The stand system of claim 1 wherein said decoy platform comprises:
a first stand wing;
a second stand wing; and
a connecting member connecting said first stand wing and said second stand wing.

3. The stand system of claim 2 wherein each of said first stand wing and said second stand wing further comprise:
a bottom section;
a sloped wall section; and
an upper section.

4. The stand system of claim 1 wherein said mount further comprises:
a bolt and bearing mount.

5. The stand system of claim 4 wherein the bolt and bearing mount further comprises:
a coupling housing a bolt;
a race and bearing assembly that accepts said bolt; and
a pole port configured to engage with said pole.

6. The stand system of claim 1 further comprising:
a motion creating assembly configured to impart motion on a decoy mounted in said stand system.

7. The stand system of claim 6 further comprising:
a connecting linkage; and
a mounting plate.

8. A decoy stand apparatus comprising:
a decoy platform;
a mount connected to said decoy platform, said mount comprising a bolt and bearing mount; and
a pole connected to said decoy platform by said mount.

9. The decoy stand apparatus of claim 8 wherein said decoy platform comprises:
a first stand wing;
a second stand wing; and
a connecting member connecting said first stand wing and said second stand wing.

10. The decoy stand apparatus of claim 8 wherein the bolt and bearing mount further comprises:
a coupling housing a bolt;
a race and bearing assembly that accepts said bolt; and
a pole port configured to engage with said pole.

11. The decoy stand apparatus of claim 8 further comprising:
a motion creating assembly configured to impart motion on a decoy mounted in said stand apparatus.

12. The decoy stand apparatus of claim 11 further comprising:
a connecting linkage; and
a mounting plate.

13. The decoy stand apparatus of claim 8 further comprising at least one of:
a spike connected to a distal end of said pole; and
a base stand connected to a distal end of said pole.

14. A stand system comprising:
a platform;
a set of retention dowels fixed at one end to the platform; and
a pole connected to the platform.

15. The stand system of claim 14 further comprising:
a spring mount formed on the platform; and
a spring connected to said spring mount and said pole.

16. The stand system of claim 14 wherein said set of retention dowels are configured to engage at least one of:
a decoy;
a keel of a decoy.

17. The stand system of claim 14 further comprising:
a spike formed on an end of said pole.

18. The stand system of claim 14 further comprising:
a base stand formed on an end of said pole.

19. The stand system of claim 14 wherein the platform further comprises:
a base plate;
a vertical bend in said base plate; and
a substantially vertical raised end.

20. The stand system of claim 19 further comprising:
a joint connecting said substantially vertical raised end to said set of retention dowels.
